(19) United States
(12) Patent Application Publication
(10) Pub. No.: US 2005/0060652 A1
(43) Pub. Date: Mar. 17, 2005

(54) Interactive system for performing automated protein identification from mass spectrometry data

(76) Inventor: David Chazin, Denver, CO (US)

Correspondence Address: PATTON BOGGS, L.L.P., 2001 ROSS AVENUE, SUITE 3000, DALLAS, TX, 75201, US

(21) Appl. No.: 10/887,496

(22) Filed: Jul. 7, 2004

Related U.S. Application Data
(60) Provisional application No. 60/485,476, filed on Jul. 7, 2003.
(60) Provisional application No. 60/485,632, filed on Jul. 7, 2003.
(60) Provisional application No. 60/485,633, filed on Jul. 7, 2003.

(51) Int. Cl. G06F 3/00; G06F 9/00; G06F 17/00

(52) U.S. Cl. 715/700

(57) ABSTRACT

A graphical user interface is provided that includes one or more of the following: indicia representing a peptide frame, indicia representing a spectral frame, and indicia representing a protein frame. By selecting a peptide, the peptide frame zooms to a corresponding location in the spectral frame. Selecting a peak in the spectral frame highlights a corresponding peptide in the peptide frame. Selecting a protein in the protein frame updates the spectral frame with respect to matching and missing peptides.

### CROSS-REFERENCE TO RELATED APPLICATIONS

This application claims the benefit of and priority to U.S. Provisional Application No. 60/485,476, filed Jul. 7, 2003, which is hereby incorporated by reference.

This application also incorporates by reference commonly-owned U.S. Provisional Application Nos. 60/485,632 and 60/485,633, both filed on Jul. 7, 2003.

### BRIEF DESCRIPTION OF THE DRAWINGS

FIG. 1 illustrates the components of the interactive computer system.

FIG. 2 shows how the ProteinProphet system works by taking a raw mass spectrometer dataset and running through the components.

FIG. 3 shows the processing of the raw input consisting of conversion of the data to our XML format, computing background, noise, and signal values, followed by charge detection, convolution of the data, peak detection and de-isotoping.

FIG. 4 shows the protein identification.

FIG. 5 shows how all of the components are tied together and presented to the user through the GUI.

FIG. 6 shows the interaction between the Protein Identification and Spectral Analysis portions of the user interface.

FIG. 7 shows the organization of the user interface.

### DETAILED DESCRIPTION OF THE PREFERRED EMBODIMENT

In the following detailed description of the preferred embodiments, reference is made to the accompanying drawings, which form a part hereof and in which is shown by way of illustration specific preferred embodiments in which the invention may be practiced. These embodiments are described in sufficient detail to enable those skilled in the art to practice the invention, and it is understood that other embodiments may be utilized and that logical software, electrical, mechanical, structural, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

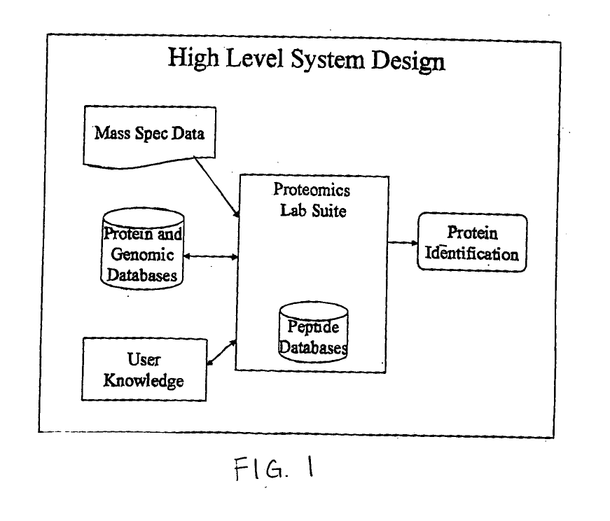

An interactive computer system for performing automated protein identification from mass spectrometry data (also referred to as “ProteinProfit”) is described herein. The unique features of ProteinProphet are:
Ability of the scientist/user to interactively annotate the spectrum by:
   1. Removing peaks in the spectrum.
   2. Inserting peaks in the spectrum
   3. Excluding entire ranges of the spectrum when performing protein identification.
Perform integrated “what-if” or “one-off” analysis through our integrated Scenario management. This allows the user to alter parameters and view their impacts concurrently on the resultant set proteins identified.
An internal XML data format to manage the storage and retrieval of experimental data. The components of the computer system are illustrated in FIG. 1.

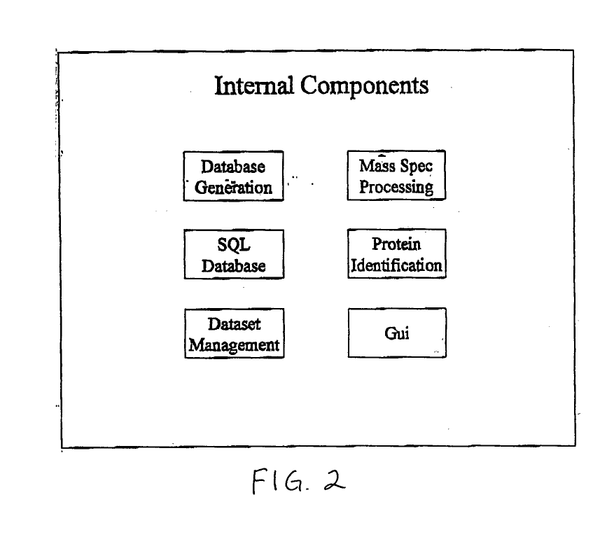

ProteinProphet works by taking a raw mass spectrometer dataset and running through the components shown in FIG. 2.

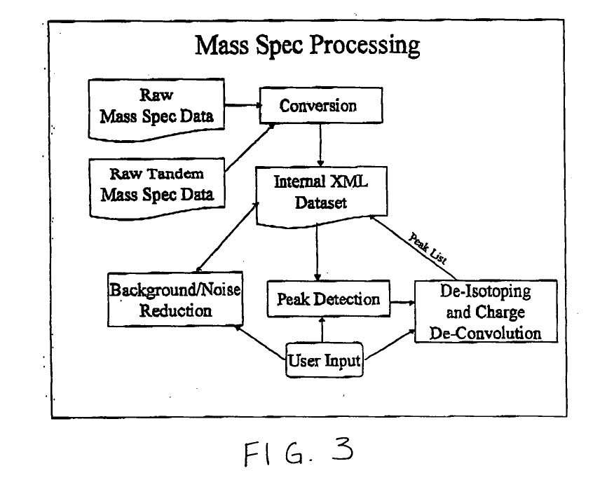

The processing of the raw input consists of conversions of the data in our XML format, computing background, noise, and signal values, followed by charge detection, convolution of the data, peak detection and de-isotoping as is shown in FIG. 3.

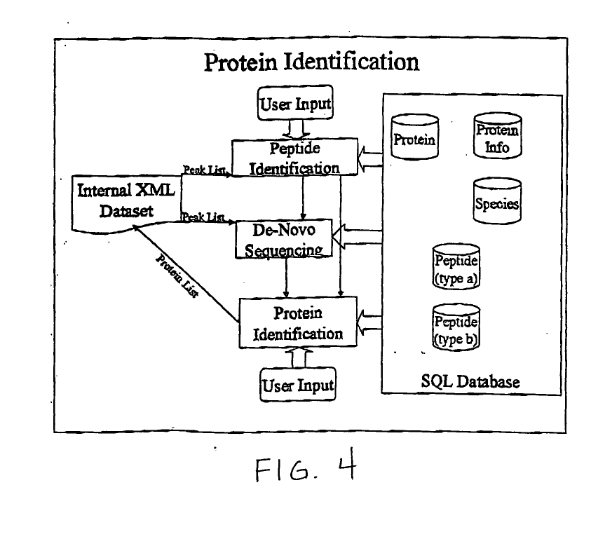

Protein identification is performed using the peak lists detected in the prior processing stages and the peptide databases. ProteinProphet uses a number of different protein identification strategies, each of which may be used by themselves or in any combination with each other. The strategies used include:
Peptide Mass Fingerprinting.
Spectrum Matching.
De-novo Sequencing.
   The protein identification strategies are illustrated in FIG. 4.

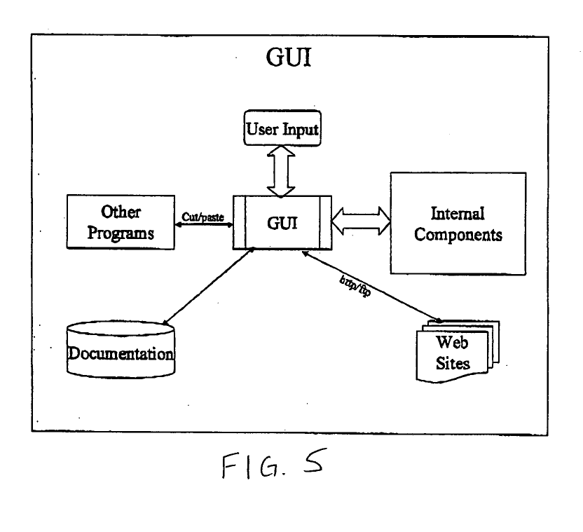

All of the components are tied together and presented to the user through the GUI which facilitates the capturing of the user's expertise in annotating the spectrum as well as creating and cataloging the various scenarios. This is shown in FIG. 5.

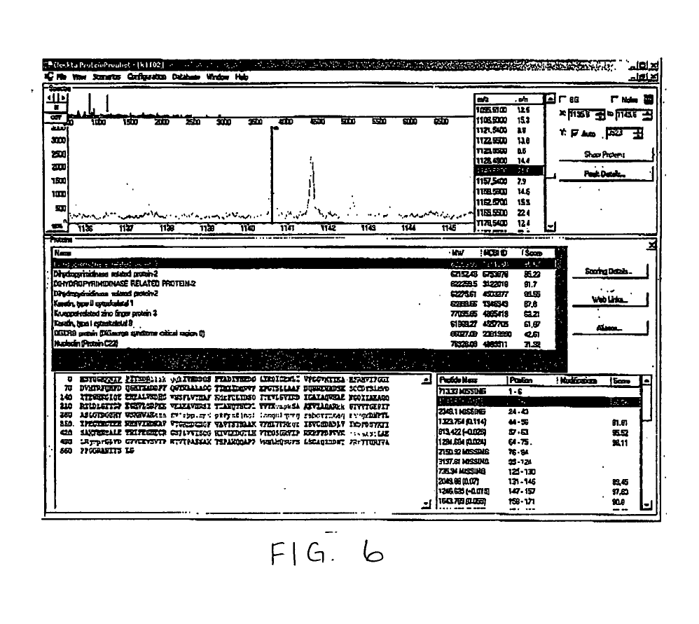

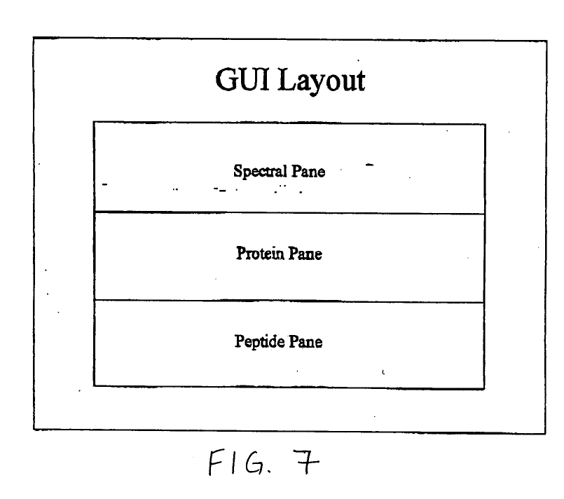

A feature of ProteinProphet is in the interaction between the Protein Identification and Spectral Analysis portions of the user interface. The user interface is shown in FIG. 6. The organization of the UI is shown in FIG. 7. The GUI features area:
1. Clicking on a Peptide in the Peptide Frame zooms to the corresponding location in the Spectral Frame.
2. Matching Peptides in the Spectral Frame are highlighted by a Colored Bar with a dot next to it.
3. Missing Peptides in the Spectral Frame are highlighted by a question mark (?).
4. Peptides in the Peptide Frame are appropriately color coded as:
   a) Found (upper case Red);
   b) Missing (upper case Black); and
   c) Excluded from identification because the mass is too low or too high to be found in the Spectra (lower case Gray).
5. Selecting a peak in the Spectral Frame (by clicking on it) highlights the corresponding peptide in the Peptide Frame.
6. Clicking on the Peak Details Button in the Spectral Frame shows all identified proteins that were matched with this peptide.
7. Selecting a protein in the Protein Frame updates the Spectral Frame for matching and missing peptides.
8. Clicking on the Aliases Button in the Protein Frame lists all known names for this protein and its homologues.

As will be recognized by those skilled in the art, the innovative concepts described in the present application can be modified and varied over a tremendous range of applications, and accordingly the scope of patented subject matter is not limited by any of the specific exemplary teachings given.

While the invention has been particularly shown and described with reference to a preferred embodiment, it will be understood by those skilled in the art that various changes in form and detail may be made therein without departing from the spirit and scope of the invention.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

1. A graphical user interface comprising:
indicia representing a Peptide Frame;
indicia representing a Spectral Frame;
indicia representing a Protein Frame;
wherein selecting a peptide in the Peptide Frame zooms to a corresponding location in the Spectral Frame;
wherein selecting a peak in the Spectral Frame highlights a corresponding peptide in the Peptide Frame; and
wherein selecting a protein in the Protein Frame update the Spectral Frame for matching and missing peptides.
